(19) United States
(12) Patent Application Publication
(10) Pub. No.: US 2011/0320622 A1
(43) Pub. Date: Dec. 29, 2011

(54) MANAGING INTERNET PROTOCOL CONNECTIVITY ACCESS NETWORK SESSIONS

(75) Inventors: Kevin Cutler, Carp (CA); Ajay Kirit Pandya, Ottawa (CA); Fan Mo, Ottawa (CA)

(73) Assignee: Alcatel-Lucent Canada, Inc., Ottawa (CA)

(21) Appl. No.: 12/826,252

(22) Filed: Jun. 29, 2010

(51) Int. Cl. G06F 15/16

(52) U.S. Cl. 709/230

(57) ABSTRACT

The invention is directed to managing a subscriber session, particularly an Internet Protocol connectivity access network (IP-CAN) session in the context of LTE networks, responsive to a change in circumstances related to the subscriber such as a change in subscriber profile information, an event trigger, or a usage management trigger. According to embodiments of the invention, such management includes receiving an indication of a change in circumstances relating to a subscriber; identifying a session related to the change; determining if taking an action related to the session is desirable; and taking the action in accordance with the determination.

### FIELD OF THE INVENTION

The invention is directed to long term evolution (LTE) networks such as specified by the 3^{rd} Generation Partnership Project (3GPP) technical specifications, particularly it relates to managing Internet Protocol connectivity access network (IP-CAN) sessions in the context of LTE networks.

### BACKGROUND OF THE INVENTION

In an effort to simplify the dual core approach of the second and third generations, the 3rd Generation Partnership Project (3GPP) has recommended a new network scheme it terms “long term evolution” (LTE). In an LTE network, all communications are carried over an IP channel from user equipment (UE) to an all-IP core called the evolved packet core (EPC). The EPC then provides gateway access to other networks while ensuring an acceptable quality of experience (QoE) and charging a subscriber for their particular network activity.

The 3GPP generally describes the components of the EPC and their interactions with each other in a number of technical specifications. Specifically, 3GPP TS 29.212, 3GPP TS 29.213, and 3GPP TS 29.214 describe the policy and charging rules function (PCRF), policy and charging enforcement function (PCEF), and bearer binding and event reporting function (BBERF) of the EPC. These specifications further provide some guidance as to how these elements interact in order to provide reliable data services and charge subscribers for use thereof.

For example, 3GPP TS 29.212 and 3GPP TS 29.214 provide some guidance on the establishment of an application session by the EPC upon receipt of an application request from an application function (AF) in the form of an authentication and/or authorization request (AAR) message or from a packet data network gateway (PGW) in the form of a credit control request (CCR) message. The standards specify that the PCRF is responsible for receiving requests, establishing IP-CAN and gateway control sessions, creating new policy and charging control (PCC) rules commensurate with such requests, and providing these new PCC rules to the PCEF for installation. The 3GPP standards also define the format of various messages and PCC rules.

Indeed, the 3GPP standards fall short of describing how the PCRF should manage an IP-CAN subscriber session in the face of a change in circumstance related to the subscriber. Therefore, it would be desirable to have away of doing so.

### SUMMARY

Embodiments of the invention are directed to managing a subscriber session responsive to a change in circumstances related to the subscriber.

According to an aspect of the invention, a method of managing a subscriber session is provided. The method comprises the steps of: receiving an indication of a change in circumstances relating to a subscriber; identifying a session related to the change; determining if taking an action related to the session is desirable; and taking the action in accordance with the determination.

In some embodiments of the invention the method comprises ascertaining if the indication is a notification of a change in profile information with respect to the subscriber, and when it is, using information in the notification to identify the subscriber and thereby the session related to the change. In such cases a plurality of sessions may be related to the change.

Additionally or alternatively to the foregoing, in some embodiments the method comprises, when the indication is a credit control request associated with an event trigger (for example a bearer going out of credit, or a bearer whose credit is reallocated), one or more policy and charging control rules governing the session are determined and then a policy decision engine is invoked to determine a desirable action in accordance with the rule or rules. Further, when the credit control request is not associated with an event trigger, a usage management module is invoked for determining a desirable action in accordance with information in the indication.

Advantageously, some embodiments of the invention provide management of an IP-CAN subscriber session when a change in circumstances related to the subscriber associated with the session occur. Such changes include a change in profile information of the subscriber and an event or a usage management trigger communicated to a policy charging and rules management node. Furthermore, in some embodiments when a PCC rule is associated to an AF session, the PORE will notify the AF session across the Rx interface if that PCC rule can no longer be satisfied.

### BRIEF DESCRIPTION OF THE DRAWINGS

The foregoing and other objects, features and advantages of the invention will be apparent from the following more particular description of the preferred embodiments, as illustrated in the appended drawings, where:

FIG. 1 illustrates an LTE or 4G mobile communications network in accordance with an embodiment of the invention;

FIG. 2 illustrates the policy and charging rules node of FIG. 1 in more detail;

FIG. 3 illustrates a method of managing a subscriber session performed by the policy and charging rules node of FIG. 1; and

FIG. 4 illustrates the method of FIG. 3 in more detail.

In the figures like features are denoted by like reference characters.

### DETAILED DESCRIPTION

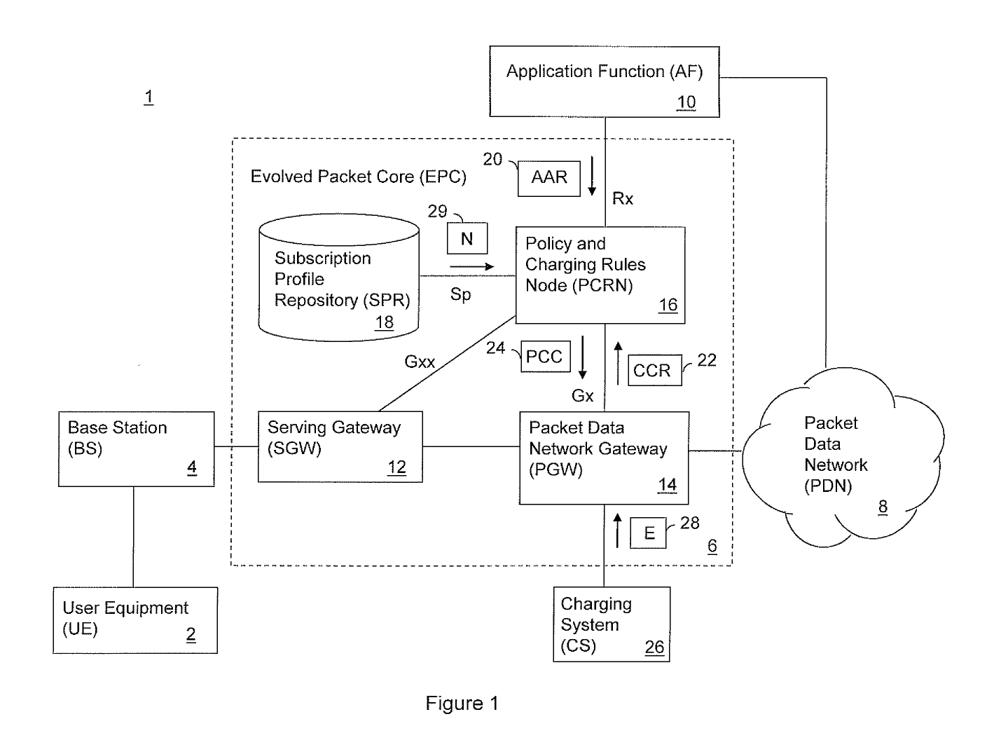

FIG. 1 illustrates an LTE or 4G mobile communications network 1 for providing access to various services. The network 1 includes user equipment 2, a base station 4, an evolved packet core (EPC) 6, a packet data network 8, and an application function (AF) 10. The user equipment 2 (e.g. a laptop computer, wireless email device, cell phone, television set-top box, etc.) communicates with the packet data network 8 via the base station 4 and the EPC 6 to provide an end-user subscriber with a data service such as voice communication, text messaging, multimedia streaming, Internet access, etc. For example, the packet data network 8 may be the Internet or another network of communications devices for providing data communications between the user equipment 2 and other devices connected to the packet data network 8, such as the AF 10.

The base station 4 could be an evolved node B (eNodeB), for example, for providing communication between the user equipment 2 and the EPC 6. Additionally, although not shown in FIG. 1, multiple base stations could be present to provide mobility support to the user equipment 2. The EPC 6 charges a subscriber for use of provided data services and ensures that QoE standards are met. Typically, the EPC 6 is implemented, at least in part, according to the 3GPP technical specifications 3GPP TS 29.212, 3GPP TS 29.213, and 3GPP TS 29.214. The EPC 6 includes a serving gateway (SGW) 12, a packet data network gateway (PGW) 14, a policy and charging rules node (PCRN) 16, and a subscription profile repository (SPR) 18.

The SGW 12 provides the user equipment 2 with gateway access to the EPC 6. Accordingly, the SGW 12 is the first device within the EPC 6 that receives packets sent by user equipment 2. The SGW 12 forwards such packets to the PGW 14. The SGW 12 may perform a number of functions such as, for example, managing mobility of user equipment 2 between multiple base stations (not shown) and enforcing particular quality of service (QoS) characteristics for each flow being served. In various implementations, such as those implementing the proxy mobile IP (PMIP) standard, the SGW 12 may include a bearer binding and event reporting function (BBERF). In some embodiments, the EPC 6 includes multiple SGWs (not shown) and each SGW may communicate with multiple base stations (not shown).

The PGW 14 provides the user equipment 2 with gateway access to the packet data network 8. The PGW 14 is the final device within the EPC 6 that receives packets sent by user equipment 2 toward packet data network 8 via the SGW 12. The PGW 14 includes a policy and charging enforcement function (PCEF) that enforces policy and charging control (PCC) rules 24 for each service data flow (SDF). Therefore, the PGW 14 operates as a policy and charging enforcement node (PCEN). The PGW 14 may include a number of additional features such as, for example, packet filtering, deep packet inspection, and subscriber charging support. The PGW 14 may also be responsible for requesting resource allocation for unknown application services. Upon receiving a request for an unknown application service from the user equipment 2, the PGW 14 constructs a credit control request (CCR) 22, requesting an appropriate allocation of resources, and forwards the CCR 22 to the PCRN 16.

The PORN 16 receives requests related to service data flows (SDFs) and IP-CAN sessions, generates PCC rules, and provides PCC rules 24 to the PGW 14 and/or other PCENs (not shown). The PORN 16 is in communication with the AF 10 via an Rx interface. From time to time, the PCRN 16 may receive an application request in the form of an AAR 20 from AF 10. Upon receipt of the AAR 20, the PCRN 16 generates at least one PCC rule 24 for fulfilling the AAR 20.

The PCRN 16 is in communication with SGW 12 via a Gxx interface and with the PGW 14 via a Gx interface. From time to time, the PCRN 16 may receive a request in the form of a credit control request, such as the CCR 22 from the SGW 12 or the PGW 14. As with the AAR 20, upon receipt of the CCR 22, the PCRN 16 takes appropriate action in response, such as generating a PCC rule 24 for fulfilling and/or responding to the CCR 22.

The AAR 20 and CCR 22 can be independent requests to be processed separately, or they may carry information regarding a single request. In the case of the latter the PORN 16 takes action based on the combination of AAR 20 and CCR 22.

Upon creating a new PCC rule 24 or upon request by the PGW 14, the PORN 16 provides a PCC rule 24 to the PGW 14 via the Gx interface. In various embodiments, such as those implementing the PMIP standard for example, the PORN 16 may also generate quality of service (QoS) rules. Upon creating a QoS rule or upon request by the SGW 12, the PORN 16 provides the QoS rule to SGW 12 via the Gxx interface.

Typically, in processing various requests and other messages, the PCRN 16 makes use of one or more behavioral rules. To do so, the PCRN 16 locates an applicable behavioral rule for a given request, conflict, or event, and takes an action specified by the behavioral rule. In some cases, such a behavioral rule may include a reference to a predefined routine that the PCRN 16 performs in response to a request or other message.

The subscription profile repository (SPR) 18 stores information related to subscribers of the network 1. Data stored by the SPR 18 includes an identifier of each subscriber and indications of subscription information for each subscriber such as subscriber category, bandwidth limits, charging parameters, and subscriber priority. In some cases, instead of being an independent node within the EPC 6, the SPR 18 may be a component of the PCRN 16.

The AF 10 is a server or other device that provides a known application service (e.g. a video streaming or voice communication service) to the user equipment 2. The AF 10 is in communication with the PCRN 16 via the Rx interface. When the AF 10 is to begin providing the known application service to the user equipment 2, the AF 10 generates an application request message defined by the Diameter protocol, such as the AAR 20, to notify the PCRN 16 that resources should be allocated for the application service. This application request message includes information such as an identification of a subscriber using the application service and an identification of the particular service data flows desired to be established in order to provide the requested service. The AF 10 communicates the application request, AAR 20, to the PCRN 16 via the Rx interface.

Typically, in operation the PCRN 16 receives requests, such as the AAR 20 or the CCR 22, to establish a new service data flow. In some cases, while attempting to establish the requested SDF, the PCRN 16 may determine that there is a conflict between the request and a subscriber profile, e.g. the request specifies more bandwidth than the subscriber is allowed. To resolve this conflict, the PCRN 16 locates an applicable behavioral rule that indicates how the request should be handled. In some cases in order to handle the request, the PCRN 16 will generate a PCC rule 24, which it will forward to the SGW 12 and PGW 14 via the Gxx and Gx interfaces, respectively, as part of establishing the requested SDF.

The network 1 may also include a charging system 26 for performing accounting functions such as billing a subscriber for an SDF as governed by a PCC rule 24 associated with the SDF. The charging system is in communication with the PGW 14 for this purpose, both to receive PCC rules 24, or information related thereto, and to provide the PGW 14 with credit event triggers such as when a subscriber is out of credit, when there has been a reallocation of subscriber credit, or when a stand along event trigger such as revalidation time-out has occurred with respect to an SDF or session. These event triggers are included herein when referring to a change in circumstances related to a subscriber. Typically, notification of the occurrence of such an event trigger is provided by the PGW 14 to the PCRN 16. The receipt of such a notification is involved in a method of managing a subscriber session according to an embodiment of the invention performed by the PORN 16, which embodiment will be described later in detail.

Another change in circumstances related to a subscriber that can occur while an SDF or session is active is related to usage of the network 1 by the subscriber. For example, the PGW 14 may generate a CCR 22, or other such notification, regarding a subscriber and the subscriber's use of a service such as it relates to one or more subscriber sessions and/or associated PCC rules 24. The CCR 22 is conveyed to the PORN 16 and upon receipt of which the PCRN 16 takes steps to manage one or more subscriber sessions related to the CCR 22, in accordance with an embodiment of a method of managing subscriber sessions as will be described later.

Still another change in circumstances related to a subscriber that can occur while an SDF or session is active is related to changes in information stored in the SPR 18 concerning the subscriber. Such changes are conveyed to the PCRN 16 via a notification 28 or other such message. Typically, when the PCRN 16 receives notification of such changes it will reload any entries in its SPR cache that concern that subscriber. Additionally, upon receipt of such notification 28, the PCRN 16 will take steps to manage sessions related to that subscriber in view of the changes to information stored in the SPR 18 or its SPR cache concerning the subscriber. These steps will be described later with respect to an embodiment of a method of managing subscriber sessions performed by the PCRN 16.

In the foregoing non-limiting examples of a change in circumstances related to a subscriber, steps are taken by the PCRN 16 to manage an existing session of the subscriber in accordance with an embodiment of the invention, the outcome of which steps may include but are not limited to: reauthorizing the session, terminating the session, and taking no action that would affect the session. Additionally, as there could be several existing sessions associated with the subscriber related to the change in circumstances, the steps embodying the method may be performed on all or only some of the sessions, as determined by the method.

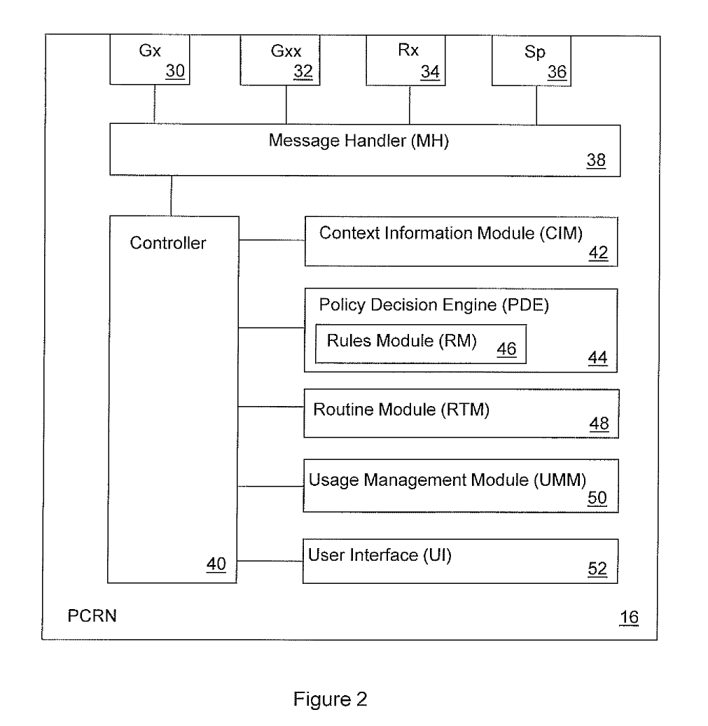

FIG. 2 depicts the PCRN 16 of FIG. 1 in more detail. The PCRN 16 includes the following interfaces: a Gx interface 30 for communicating with the PGW 14, a Gxx interface 32 for communicating with the SGW 12, an Rx interface 34 for communicating with the AF 10, and an Sp interface 36 for communicating with the SPR 18. These interfaces are coupled to a message handler 38 for receiving messages received from the interfaces and for transmitting messages from the PCRN 16 via the interfaces. In some embodiments the message handler (MH) 38 is operable to process messages received from the interfaces and to formulate messages for transmission via the interfaces. The extent of such processing and formulating capabilities resident in the message handler 38 is dependent upon distribution of such capabilities between the message handler 38 and a controller 40 in communication therewith. The controller 40 performs or directs execution of many functions performed by the PCRN 16 including steps of the method of managing a subscriber session in accordance with an embodiment of the invention. As such, the controller 40 is in communication with subsystems of the PCRN 16 including a context information module (CIM) 42, a policy decision engine (PDE) 44 which includes a rules module (RM) 46, a routine module (RTM) 48, a usage management module (UMM) 50 and a user interface (UI) 52.

The subsystems and modules of the PCRN 16 and their respective functions will now be described in more detail.

The Gx interface 30 may be an interface comprising hardware and/or executable instructions encoded on a machine-readable storage medium configured to communicate with a PGW such as the PGW 14. Such communication may be implemented according to the 3GPP TS 29.212. Thus, the Gx interface 30 may receive transmit PCC rules for installation and rejections of application requests. The Gx interface 30 may further receive UE-originated application requests, session requests, and event notifications in the form of a CCR 22.

The Gxx interface 32 may be an interface comprising hardware and/or executable instructions encoded on a machine-readable storage medium configured to communicate with an SGW such as the SGW 12. Such communication may be implemented according to the 3GPP TS 29.212. Thus, the Gxx interface 32 may transmit QoS rules for installation and rejections of application requests. The Gxx interface 32 may further receive UE-originated application requests, session requests, and event notifications in the form of a CCR.

The Rx interface 34 may be an interface comprising hardware and/or executable instructions encoded on a machine-readable storage medium configured to communicate with an AF such as the AF 10. Such communication may be implemented according to the 3GPP TS 29.214. For example, the Rx interface 34 may receive application requests, session requests, and event notifications in the form of an AAR 20 and transmit answers, rejections, and other status notifications in the form of an authentication and/or authorization answer (AAA) message or a reauthorization request (RAR) message.

The Sp interface 36 may be an interface comprising hardware and/or executable instructions encoded on a machine-readable storage medium configured to communicate with a SPR such as the SPR 18. Thus, the Sp interface 36 may transmit record requests and receive subscription profile records. In various embodiments, where SPR 18 is a component of the PCRN 16, the Sp interface 36 may be the SPR 18 itself or act as a frontend to the local SPR.

The message handler 38 may include hardware and/or executable instructions on a machine-readable storage medium configured to communicate messages via the Gx interface 30, the Gxx interface 32, the Rx interface 34, and the Sp interface 36. The message handler 38 is configured to receive messages from the controller 40 and to transmit them to the appropriate network devices. For example, if the message handler 38 receives an AAA destined for the AF 10 from the controller 40, the message handler 38 may transmit the AAA to the AF 10 via Rx interface 34. As another example, if the message handler 38 receives a RAR message destined for PGW 14 from the controller 40, the message handler 38 may transmit the RAR to PGW 14 via the Gx interface 30.

The controller 40 may include hardware and/or executable instructions on a machine-readable storage medium configured to process application and session requests received via Gx interface 30, Gxx interface 32, and the Rx interface 34. For example, the controller 40 may create and install new PCC rules in response to an application request. As a further example, the controller 40 may establish, modify, or terminate IP-CAN sessions and gateway control sessions in response to a session request. After fully processing a message, the controller 40 may construct and transmit a message over the Gx interface 30, the Gxx interface 32, and/or Rx interface 34 to notify other nodes as to the result of processing the message. For example, if controller 40 creates a new PCC rule 24 in response to a request message, it may construct a RAR message to push the new PCC rule to an appropriate PGW 14.

In processing various messages, the controller 40 may request a policy decision from the policy decision engine 44 and base at least part of its response to the message on the policy decision results. The controller 40 may provide context information from the message to policy decision engine 44, either directly or via the context information module 42. Policy decision results may include an indication of an action that the controller 40 should take in response to a message, in which case the controller 40 may perform the specified action. Alternatively or additionally, policy decision results may include an indication of a predefined routine. In such a case, the controller 40 may retrieve the predefined routine from routine module 48 and subsequently perform the routine. The routine may include one or more steps or actions to be taken by the controller 40.

The controller 40 is operable to receive a request for the establishment of an SDF and to generate one or more PCC and/or QoS rules for establishing the requested SDFs. The controller 40 may use information contained in the request, information from an SPR such as SPR 18, the results of a policy decision from the PDE 44 and or any other information or methods recognized by those of skill in the art as useful in generating appropriate rules for each SDF. After generating such appropriate rules, the controller 40 may store the rules in local storage and generate a message for installing the rules in the appropriate nodes. For example, the controller 40 may generate a CCA or RAR for installing the PCC rule 24 in the SGW 12. In various embodiments, the controller 40 may also generate a CCA or RAR for installing corresponding QoS rules in at least one PGW, such as PGW 14. After generating such messages, the controller 40 may forward the messages to message handler 38.

The context information module 42 may include hardware and/or executable instructions on a machine-readable storage medium configured to provide various context information to the policy decision engine 44. For example, the context information module 42 may store information carried by a received message. The context information module 42 may further store previously received and/or transmitted messages associated with a subscriber, session, and/or service data flow. The context information module 42 may further access information stored elsewhere such as, for example, subscriber information stored in an SPR such as the SPR 18.

The policy decision engine 44 may include hardware and/or executable instructions on a machine-readable storage medium configured to identify rules stored in the rule module 46 that are applicable to a received message or current context. Each rule may include a criteria section which indicates when the rule is applicable. The policy decision engine 44 may compare this criteria section to context information passed by controller 40 and/or retrieved from context information module 42. Upon locating an applicable rule, policy decision engine 44 may return the results portion of the rule to the controller 40.

The rules module 46 may include hardware and/or executable instructions on a machine-readable storage medium configured to define, modify, and otherwise manage policy decision rules. For example, the rules module 46 may receive a definition of a new policy decision rule via the user interface 52, format the definition according to a standard policy decision rule syntax used by PCRN 16, and store the definition in rule storage which may be part of the rules module 46. The rules module 46 may further provide a definition of an existing policy decision rule to a user upon request via the user interface 52. The rules module 46 may subsequently receive a modified rule definition, format the definition if necessary, and store the definition in rule storage. In storing a modified definition, the rules module 46 may overwrite an existing definition or store the modified definition as a new version of the policy decision rule while preserving the old definition. Thus, the rules module 46 may provide version control functionality. Rule storage may be any machine-readable medium capable of storing policy decision rules for use by policy decision engine 44. Accordingly, the rules module 46 may include a machine-readable storage medium such as read-only memory (ROM), random-access memory (RAM), magnetic disk storage media, optical storage media, flash-memory devices, and/or similar storage media. In various alternative embodiments, rule storage may be a device that is external to PCRN 16. Rule storage may store definitions of numerous policy decision rules. Such definitions may include, for example, rule names, service data flow filters, QoS parameters, and charging parameters.

The routine module 48 may include hardware and/or executable instructions on a machine-readable storage medium configured to define, modify, and otherwise manage routines. For example, the routine module 48 may receive a definition of a new routine via the user interface 52, format the definition according to a standard routine syntax used by PCRN 16, and store the definition in a routine storage, which may be part of the routine module 48. The routine module 48 may further provide a definition of an existing routine to a user upon request via the user interface 52. The routine module 48 may subsequently receive a modified routine definition, format the definition if necessary, and store the definition in the routine storage. In storing a modified definition, the routine module 48 may overwrite an existing definition or store the modified definition as a new version of the routine while preserving the old definition. Thus, the routine module 48 may provide version control functionality. The routine storage may be any machine-readable medium capable of storing predefined routines for use by the controller 40. Accordingly, the routine storage may include a machine-readable storage medium such as read-only memory (ROM), random-access memory (RAM), magnetic disk storage media, optical storage media, flash-memory devices, and/or similar storage media. The routine storage may be an independent storage device or may be the same as the rule storage. In various alternative embodiments, routine storage may be a device that is external to PCRN 16. The routine storage may store definitions of numerous predefined routines. Such definitions may include, for example, a name, conditional statements, and/or indications of actions to be taken.

The usage management module 50 may include hardware and/or executable instructions on a machine-readable storage medium configured to receive a notification respecting network usage of a subscriber, such notification being in the form of a CCR 22 from the PGW 14, and from that determine if it would be desirable to take any action, including those deemed mandatory, optional or otherwise, regarding sessions of that subscriber. The PCRN 16 registers with the PGW 14 using a Usage-Monitoring-Information (UMI) attribute-value-pair (AVP), which contains a Usage Monitoring Key, a next reporting quota, and a usage reporting level. This UMI AVP is used to instruct the PGW 14 to monitor usage for a subscriber IP-CAN session, or PCC rule(s) associated with the subscriber IP-CAN session. When the PGW 14 detects that the usage for a given usage monitoring key exceeds the instructed quota, it sends notification to the usage management module 50, which then determines the affected session, PCC rule(s), and takes any necessary or advisable actions. For example, the usage management module 50 may determine from the notification which session or sessions and one or more PCC rules related thereto are in question regarding usage information contained in the CCR 20 and an indication of the subscriber associated with the session or sessions. Using the key as an index to usage management rules, which may be specific to the subscriber or a group of subscribers, the usage management module compares usage information contained in the CCR 20 to one or more predetermined criteria such as thresholds to determine if it would be desirable to take any action with respect to the subscriber's session or sessions. Such action could include, but is not limited to, reauthorizing, terminating, or taking no action with respect to one or more of the subscriber's sessions. Using the accumulated usage as criteria in the policy decision rules, usage management module allows operators to write rules to take actions, beside some predetermined actions when subscriber accumulated usage exceeds some preset thresholds.

The user interface 52 may include hardware and/or executable instructions on a machine-readable storage medium configured to provide a user with access to PCRN 16. The user interface 52 may receive input from a user and may include hardware such as, for example, a keyboard and/or mouse. The user interface 52 may also display information as output to the user and may include, for example, a monitor. A user may access the rules module 46 and/or the routine manager 48 via the user interface 52.

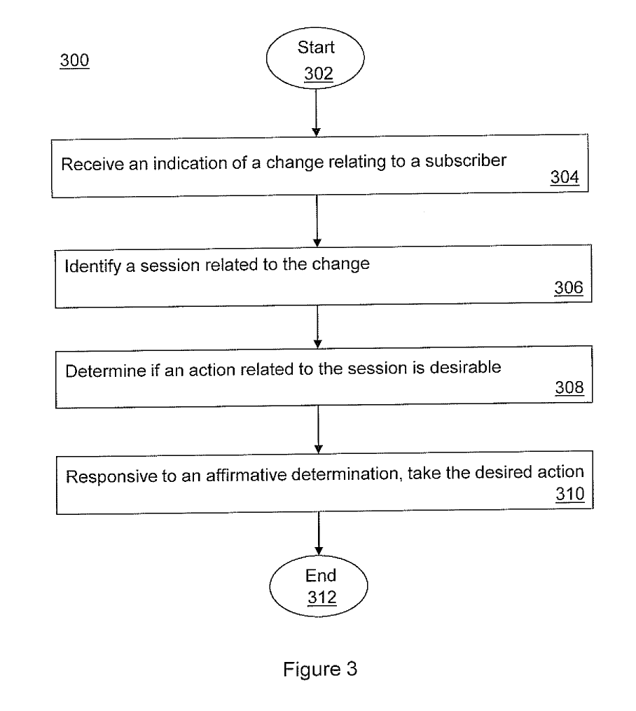

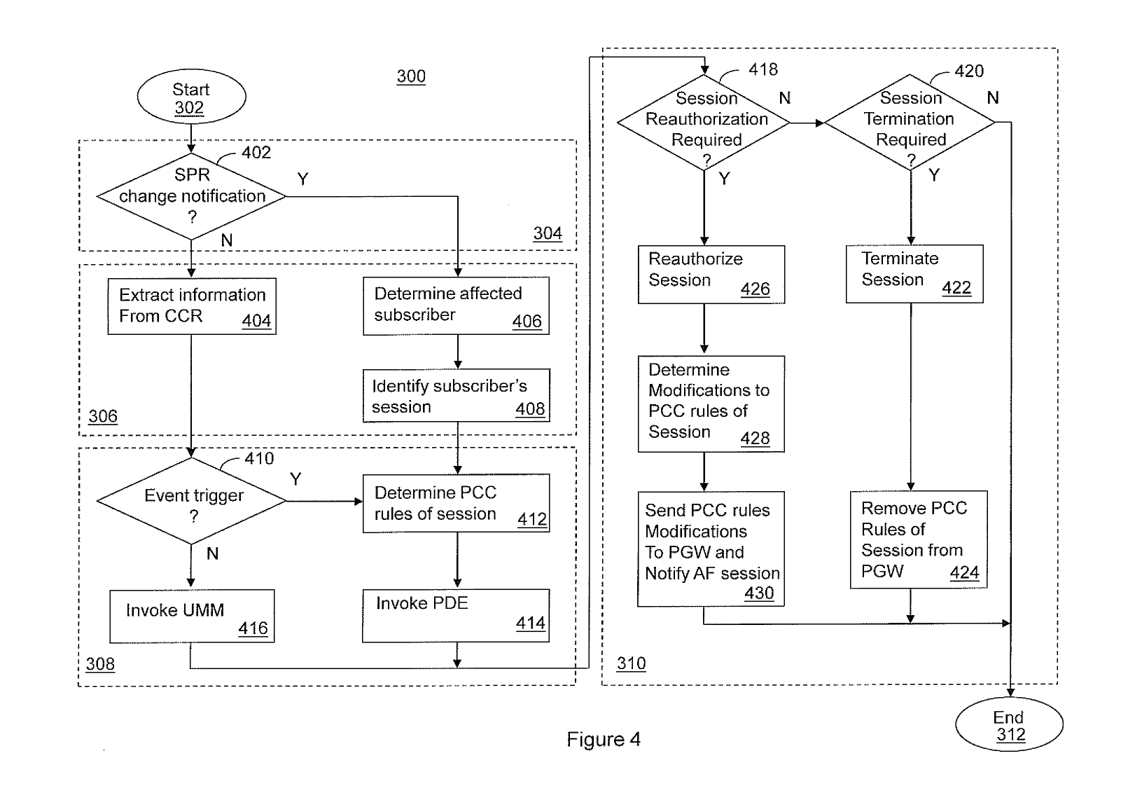

FIG. 3 depicts a method 300 of managing a subscriber session performed by the PCRN 16 according to an embodiment of the invention. In the method 300 depicted in FIG. 3 and FIG. 4, it should be noted that all affected IP-CAN sessions are determined, particularly in the case of changes made to subscriber information e.g. in the SPR 18, and the operations indicated by the method 300 are performed per affected IP-CAN session until all are processed.

Referring to FIG. 3, after starting 302 the method 300 proceeds to a step of receiving 304 an indication of a change in circumstances relating to a subscriber. Such an indication includes but is not limited to an event trigger, a usage management notification, and a notification that a change in information related to the subscriber has been made in the SPR 18. After receiving 304 the indication, the method 300 proceeds to a step of identifying 306 a session or sessions related to the change. Such identification may be made directly from information contained in the notification, or indirectly from information contained in the notification that identifies a subscriber related to the change. For example, as in the case of the PCRN 16 receiving a CCR specifying a subscriber related to an event trigger or usage management notification. After identifying 306 the session, the method 300 proceeds to a step of determining 308 if taking an action related to the session is desirable. For example, in the case of a usage management notification the PCRN 16 would invoke the usage management module 50, and using rules associated therewith and information from the notification, the usage management module 50 could determine if it would be desirable to reauthorize the session, terminate the session, or take no action with respect to the session. Finally, after making such a determination 308, the method 300 proceeds to a step of taking 310 a desired action if one is so specified by the determination 308.

FIG. 4 depicts the method 300 in greater detail. The step of receiving 304 an indication includes ascertaining 402 if the indication is a notification of a change in profile information with respect to the subscriber. For example such a notification could be with respect to a change in information about subscribed services or QoS levels of the subscriber in the subscriber profile repository 18. The step of identifying 306 a session related to the change includes, responsive to ascertaining 402 that the indication is such a notification, determining 406 an identifier of the subscriber associated with the change and, from the identifier of the subscriber, determining 408 the session or sessions related to the change. The step of identifying 306 a session related to the change also includes extracting 404, responsive to the indication not being a notification of a change in profile information, information from the indication that identifies the session related to the change, for example when the indication is a credit control request.

The step of determining 308 if taking an action related to the session is desirable includes determining 410, responsive to the indication not being a notification of a change in profile information with respect to the subscriber, if the indication is associated with an event trigger related to the subscriber. The step of determining 308 further includes invoking 416, responsive to the indication not being associated with such an event trigger, a usage management module for determining a desirable action in accordance with information in the indication. The step of determining 308 if taking an action related to the session is desirable also includes determining 412, responsive to the indication being associated with such an event trigger or the indication being a notification of a change in profile information with respect to the subscriber, a rule governing charging of the session, such as a policy and charging control rule, and invoking 414 a policy decision engine for determining a desirable action in accordance with the rule.

The step of taking 310 the action in accordance with the determination 308 includes ending 312 the method 300 responsive to determining 308 that taking an action related to the session is not desirable, such as reauthorizing or terminating the session. The step of taking 310 the action in accordance with the determination 308 also includes determining 418 if reauthorization of the session is desirable and reauthorizing 426 the session in such a case. The step of reauthorizing 426 the session is followed by determining 428 a change to one or more PCC rules governing charging of the session and causing the change to take affect, such as sending 430 the change to the packet data network gateway 14. This step of sending 430 may also include notifying an AF session owning the PCC rule (if applicable). Such notification could be in the form of a RAR or abort session request (ASR) message depending on if the session is partially affected or fully affected, respectively. The step of taking 310 the action in accordance with the determination 308 also includes determining 420 if termination of the session is desirable, which in the affirmative case the session is terminated 422, a rule governing charging of the session is determined and removal of the rule from a packet data network gateway 14 is requested 424.

Basically, when the action of reauthorizing a session is taken it involves accessing information for the subscriber from either in the SPR cache of the PCRN 16 or from the SPR 18, and comparing the requirements of the session to one or more limitations for the subscriber that are specified by the accessed information. Such information stored by the SPR 18 may include identifiers for each subscriber and indications of subscription information for each subscriber such as, for example, bandwidth limits, charging parameters, and subscriber priority. Bandwidth limits may further be defined per application, per access point name (APN), and/or per QoS class identifier (QCI). By ensuring that authorization of the session would not violate limits contained in a subscription profile record, the PCRN 16 may ensure that only valid requests are fulfilled while implementing per subscriber, per APN, per QCI, and/or per application usage limits.

In summary, based on some trigger (e.g. a subscriber record change, a subscriber usage threshold crossing or other network event) the PCRN 16 can initiate a full or partial IP-CAN session reauthorization. As part of this process all active PCC rules 24 against a session are reauthorized based on the current state of the network 1. The PCC rules 24 which are no longer authorized are uninstalled (e.g. from the PGW 14) and associated AF sessions are notified. For example, an operator changes a given subscriber record in the SPR 18 by reducing the available bandwidth for a given application. There is a rule in place in the PCRN 16 that determines a reauthorization should take place. The PCRN 16 evaluates all PCC rules 24 associated with the subscriber session for this application and determines if the PCC rules, and thereby the subscriber session, can still be authorized based on the new lower bandwidth limitation. If certain PCC rules 24 can no longer be authorized they are removed from the network via the Gx and/or Gxx interfaces 30, 32 and the associated application is notified via the Rx interface 34.

Numerous modifications, variations and adaptations may be made to the embodiments of the invention described above without departing from the scope of the invention, which is defined in the claims.

What is claimed is:

1. A method of managing a subscriber session, comprising:
performing, by a policy and rules charging node, the steps of:
receiving an indication of a change in circumstances relating to a subscriber;
identifying a session related to the change;
determining if taking an action related to the session is desirable; and
taking the action in accordance with the determination.

2. The method of claim 1, wherein the step of receiving comprises ascertaining if the indication is a notification of a change in profile information with respect to the subscriber.

3. The method of claim 2, wherein the step of identifying comprises determining, responsive to ascertaining that the indication is the notification, an identifier of the subscriber associated with the change and determining, from the identifier of the subscriber, the session related to the change.

4. The method of claim 2, wherein the step of identifying comprises extracting, responsive to ascertaining that the indication is not the notification, information identifying the session related to the change.

5. The method of claim 3, wherein the notification indicates that a change in a subscriber profile repository has been made.

6. The method of claim 4, wherein the indication is a credit control request.

7. The method of claim 4, comprising checking if the indication is associated with an event trigger related to the subscriber.

8. The method of claim 7, wherein the step of determining if taking an action related to the session is desirable comprises invoking, responsive to the indication not being associated with an event trigger, a usage management module for determining a desirable action in accordance with information in the indication.

9. The method of claim 7, wherein the step of determining if taking an action related to the session is desirable comprises determining, responsive to the indication being associated with an event trigger, a rule governing charging of the session.

10. The method of claim 9, wherein the step of determining if taking an action related to the session is desirable further comprises invoking a policy decision engine for determining a desirable action in accordance with the rule.

11. The method of claim 10, wherein the rule is a policy and charging control rule.

12. The method of claim 3, wherein the step of determining if taking an action related to the session is desirable comprises determining a rule governing charging of the session.

13. The method of claim 12, wherein the step of determining if taking an action related to the session is desirable further comprises invoking a policy decision engine for determining a desirable action in accordance with the rule.

14. The method of claim 13, wherein the rule is a policy and charging control rule.

15. The method of claim 1, wherein taking the action comprises ending the method responsive to determining that taking an action related to the session is not desirable.

16. The method of claim 1, wherein taking the action comprises reauthorizing the session.

17. The method of claim 16, wherein reauthorizing the session comprises determining a change to a rule governing charging of the session and causing the change to take affect.

18. The method of claim 17, wherein causing the change to take affect comprises sending the change to a packet data network gateway.

19. The method of claim 1, wherein taking the action comprises terminating the session.

20. The method of claim 19, wherein terminating the session comprises determining a rule governing charging of the session and requesting removal of the rule from a packet data network gateway.

21. The method of claim 1, wherein the session is an Internet Protocol connectivity access network session.
